(19) United States
(12) Patent Application Publication
(10) Pub. No.: US 2002/0033849 A1
(43) Pub. Date: Mar. 21, 2002

(54) Graphical user interface

(75) Inventors: Fabrizio Loppini, Rome (IT); Paolo Bianchini, Rome (IT)

Correspondence Address: Edward H. Duffield, IBM Corp, IP Law Dept T81/503, 3039 Cornwallis Road, PO Box 12195, Research Triangle Park, NC, 27709-2195, US

(73) Assignee: International Business Machines Corporation, Armonk, NY

(21) Appl. No.: 09/846,572

(22) Filed: May 1, 2001

(30) Foreign Application Priority Data
Sep. 15, 2000 (GB) 0022613.4

(51) Int. Cl. G06F 3/14

(52) U.S. Cl. 345/848

(57) ABSTRACT

A graphical user interface system for displaying a plurality of icons has a desktop which conceptually provides a three-dimensional surface for the icons. The surface is represented on a two-dimensional display device and navigation of the desktop is supported by simulating a rotation of the surface in three-dimensional space. Furthermore, the desktop is viewed at an apparent distance from a user viewpoint and each of the plurality of icons is viewed at a viewing distance based on the apparent distance and location of each of the plurality of icons on the three-dimensional surface. Additionally, each of the plurality of icons is scaled by the relevant viewing distance. The apparent distance between the viewpoint and the desktop can be changed.

### TECHNICAL FIELD OF THE INVENTION

The present invention relates to a graphical user interface, particularly for use in a computer system.

### BACKGROUND OF THE INVENTION

Data processing systems are usually provided with a graphical user interface (GUI) to allow an end user to control the data processing system and to present the results of user actions on the system display. In a graphical user interface, applications and data are generally presented as objects depicted on a user interface. A user is then provided with a graphical, intuitive interface to a complex data processing system which permits graphic selection of depicted objects and manipulation of applications corresponding to those objects.

The graphical intuitive interface is a “desktop” which utilizes a physical desktop metaphor. The desktop includes at least one workspace, which is a work surface for end users to store, manipulate, and view system objects. Conventional desktops typically display a single front panel in the workspace. This panel contains icons representing frequently used objects, such as data files, controls, applications, and devices. Applications include, for example, text editors, databases, file managers, and games.

There are a number of different graphical user interface environments commercially available which utilize the arrangement described above, such as the Windows graphical user interface developed by the Microsoft Corporation (Windows is a trademark of Microsoft Corporation) and the OS/2 Presentation Manager developed by International Business Machines Corporation (OS/2 and Presentation Manager are trademarks of International Business Machines Corporation).

With regard now to FIG. 1, the prior art graphical is a single desktop 100. Execution of an application program involves one or more user interface objects represented by icons 110, 120 and 130. Typically, there may be several other icons 140, 150 and 160 simultaneously present on the desktop resulting in the desktop assuming a cluttered appearance. Some of the icons can overlay other icons, or other graphical elements. Therefore the user needs to move the foreground icons to operate on hidden elements.

A further problem associated with graphical user interfaces, is that there is often not enough space available for the end user to place icons, windows and so on. A known alternative is a desktop including multiple workspaces, which enables the end user to group similar icons and windows into meaningful sets.

A cascade technique, as shown in FIG. 2, arranges the workspaces 210 to 250 so that each workspace is offset on two sides from the workspace it overlaps. The workspaces 210 to 250 appear to be stacked one behind the other. This technique minimizes the desktop area 200 where workspaces are displayed. Using the cascade technique, it is difficult to work with two workspaces at the same time.

A variation of the cascade technique is the Common Desktop Environment (CDE), which is a standard graphical user interface for open systems desktop computing wherein multiple self-contained workspaces are implemented by means of a single front panel displayed in each workspace. The front panel displays various widgets, such as workspace switches, controls, and object icons. Therefore, only one workspace is displayed at any time.

A disadvantage of multiple workspaces is the lack of continuity between workspaces. When an end user switches from one workspace to another, it is simply a process of replacement of different groups of icons. Also, the process of stepping through multiple workspaces to find groups of icons can be confusing to an end user. Furthermore, although multiple workspaces typically group icons with a logical affinity (word processor and its document, working sessions, database and views/tables and so on) there is no perception of a global view.

Thus, there is a need to improve the desktop computing environment and, more particularly, but without limitation, to provide a system for allowing improved display of icons and generic objects usually placed on the desktop of operating systems.

### SUMMARY OF THE INVENTION

Accordingly the invention provides a graphical user interface system for displaying a plurality of icons, said system further comprising means for depicting a desktop which conceptually provides a three-dimensional surface for said icons, in which said three dimensional surface is represented on a two-dimensional display device, and means for supporting navigation of said desktop by simulating a rotation of the desktop or surface in three-dimensional space.

The use of a three-dimensional surface as the desktop increases the space available on which to place icons, but at the same time the surface is intuitive and natural to the end user for navigation. In a preferred embodiment the three-dimensional surface is spherical, providing a continuous view of the desktop to the end user and one whose topology may be easily comprehended.

In a preferred embodiment of the present invention the desktop is viewed at an apparent distance from a user viewpoint, which can be changed by the end user. The means for depicting a desktop includes means for calculating a viewing distance for each of the icons based on the apparent distance and location of the icon on the three-dimensional surface, and means for scaling each of the icons by the relevant viewing distance. This allows the end user to gain a perspective view of the desktop, enhancing the three-dimensional impression for an end user. It also means that icons that are not the current focus of user attention (for example, the centre of the spherical desktop) are typically reduced in size, thereby helping to make the most efficient use of screen space for the desktop. (Note that in the current preferred embodiment, icons are not distorted or foreshortened in relation to the angle of the three-dimensional surface to the display device, but this could be added if desired.)

In a preferred embodiment of the present invention, an array stores the position of each icon. Typically new icons are added by default to the centre of the desktop, but specific user positioning is also supported. Each icon position is stored as a two-dimensional co-ordinate relative to the display device following rotation of the desktop. The new two-dimensional co-ordinate is determined for each icon, and the array is updated accordingly. The new two-dimensional co-ordinates are determined by first transforming the two-dimensional co-ordinate of each icon into a three-dimensional co-ordinate; then changing the three-dimensional co-ordinates based on the rotation of the desktop; and finally transforming the changed three-dimensional co-ordinates into a new two-dimensional co-ordinate for each icon. Storing icon positions in (x, y) display co-ordinates is convenient and straightforward, but a conversion into three-dimensions is generally required for most manipulations of the desktop, such as rotation. An alternative approach would be to store the icon positions Inin term of their three-dimensional co-ordinates on the desktop, however, this would require conversion back to two-dimensional display co-ordinates each time the desktop is redrawn.

Preferably, the end user utilizes familiar and simple tools for orientation and movement of the desktop. Thus, in a preferred embodiment the means for supporting navigation is responsive to either dragging the desktop with a pointing device or dragging an icon beyond the desktop with a pointing device, in order to rotate the desktop. Other manipulation techniques such as via an explicit tool or widget may also be provided.

Preferably, the icons are grouped automatically according to pre-determined criteria, for example, grouping by frequency of use of applications, or by type of application. The grouping could alternatively be implemented manually by an end user. The ability to group icons allows the end user to structure the global view of the desktop to assist navigation.

The above graphical user interface functionality will typically be included in an operating system or graphics package. Thus, in another aspect, there is provided a computer program product for displaying a plurality of icons, said computer program product comprising computer program instructions on a computer readable medium, said instructions causing the computer to perform the steps of depicting a desktop which conceptually provides a three-dimensional surface for said icons, in which said three dimensional surface is represented on a two-dimensional display device, and supporting navigation of said desktop by simulating a rotation of the desktop in three-dimensional space.

### BRIEF DESCRIPTION OF THE DRAWINGS

The present invention will now be described, by way of example only, with reference to preferred embodiments thereof as illustrated in the following drawings:

FIG. 1 shows schematically a prior art graphical user interface;

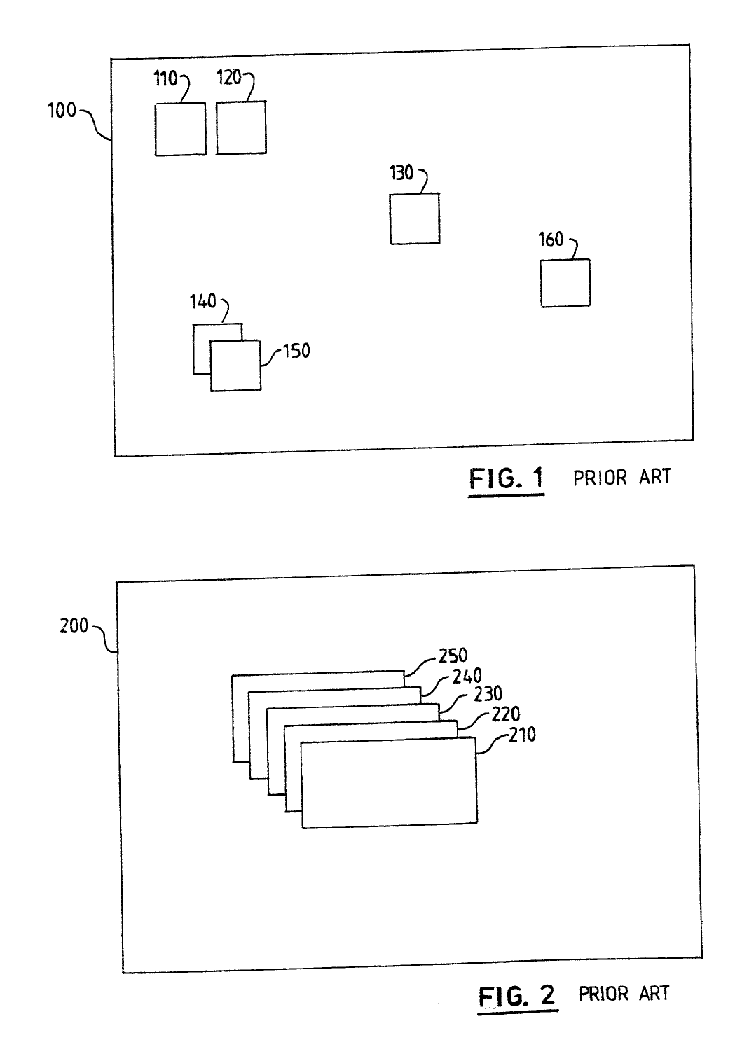

FIG. 2 shows schematically a prior art cascade technique for displaying multiple workspaces;

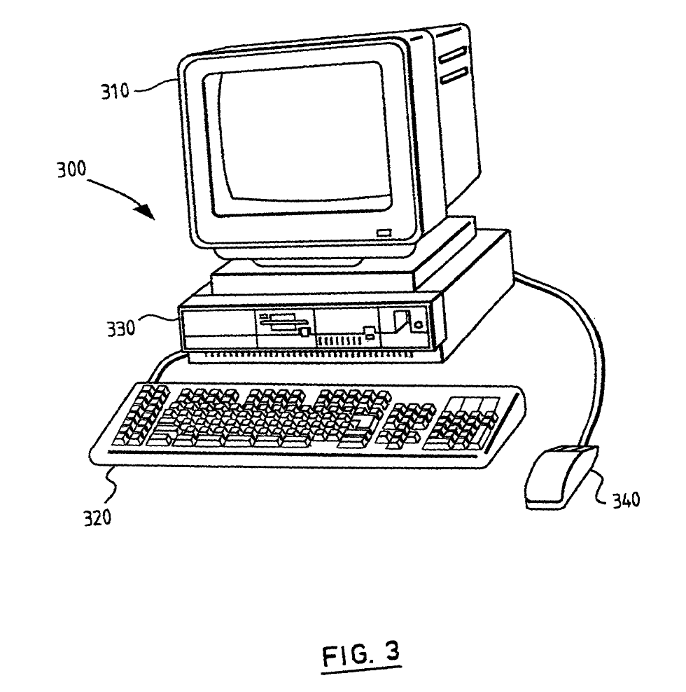

FIG. 3 shows schematically a computer system which may be utilized to implement the method and system of the present invention;

FIG. 4 shows schematically a 3-dimensional spherical desktop and logical groupings of objects, according to the present invention;

FIG. 5 is a flow chart showing the operational steps involved in navigating a 3-dimensional spherical desktop according to the present invention;

FIG. 6 shows schematically the rotation of a 3-dimensional spherical desktop according to the present invention;

FIG. 7 shows schematically the 3-dimensional spherical desktop and logical groupings of objects of FIG. 4, after a rotation of the desktop;

FIG. 8 shows schematically the 3-dimensional desktop and the position and distance of an icon from an end user, after movement of the icon; and

FIG. 9 shows schematically the 3-dimensional desktop and the position and distance of an icon from an end user, after changing the distance between the end user and the sphere.

### DETAILED DESCRIPTION OF THE PREFERRED EMBODIMENT OF THE INVENTION

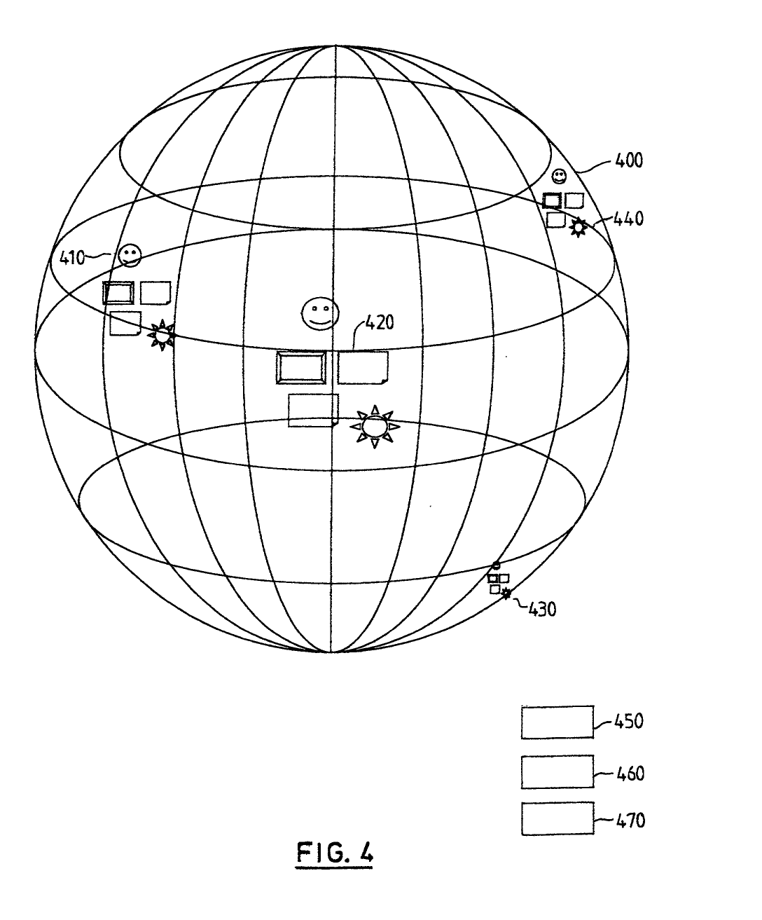

With reference to FIG. 3, there is depicted a computer 300 which may be utilized to implement the method and system of the present invention. The computer 300 preferably includes a display unit 310 and a keyboard 320, coupled in a manner well known in the art. Additionally, the computer 300 includes a processor system unit 330 which may serve to mount a fixed disk drive and a diskette drive in addition to the main processor and memory. Further, in order to facilitate the utilization of a graphical user interface, computer 300 preferably includes a graphic pointing device, such as a mouse 340, which may be utilized to manipulate the position of a pointer (not shown) within a visual display on the screen 310. Those skilled in the art will appreciate that computer 300 may be implemented utilizing any state-of-the-art personal computer, such as the Aptiva manufactured by International Business Machines Corporation. (Aptiva is a trademark of International Business Machines Corporation).

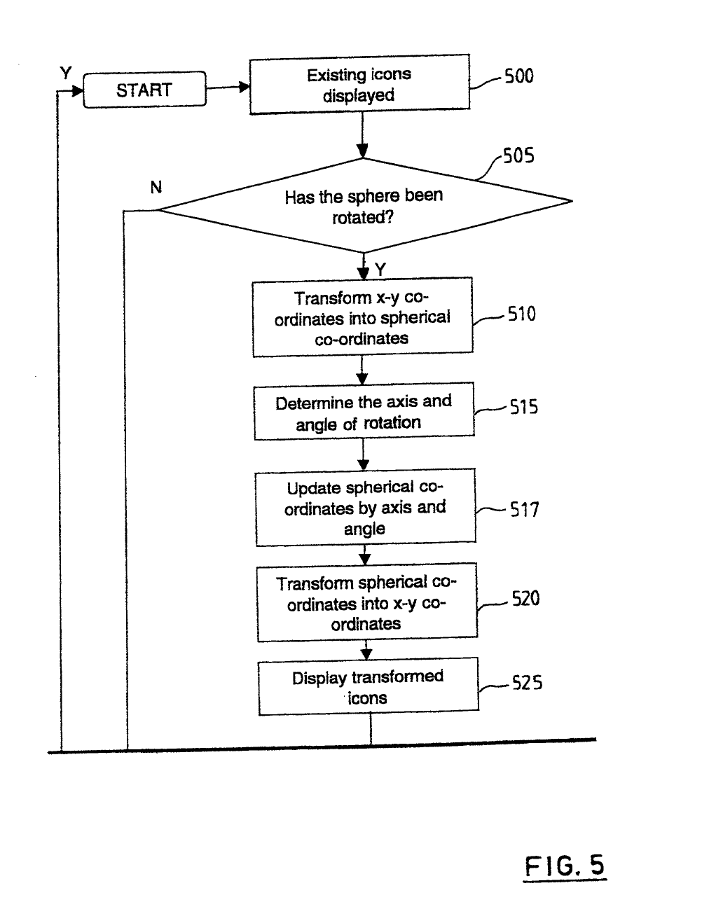

FIG. 4 is a schematic representation of an improved desktop according to the present invention, where there is shown a representation of a 3-dimensional spherical desktop 400, in contrast to 2-dimensional desktops and multiple virtual desktops. Groups of icons are depicted, for example at 410 and 420.

In the preferred embodiment, the spherical surface is displayed with gridlines in to order to aid end user orientation on the surface. It should be understood that the screen display of spheres per se is not new, and is widely used in applications such as solid modelling, of which further information can be found in “An Introduction to Ray Tracing” edited by Andrew S. Glassner, Academic Press, 1989, see especially Chapter 2 by Eric Haines. Accordingly, the relevant graphical techniques are familiar to the skilled person.

An icon may be added to the desktop by the end user, for example by placing the corresponding file in an appropriate directory or by dragging and dropping onto the desktop in conventional fashion.

Typically, the end user views logical groups of objects lying on the same areas of the sphere 400. The groups of objects are represented by groups of icons, namely 410, 420, 430 and 440. The process of grouping the icons is implemented either manually by the end user, or automatically, for example grouping based on file type. This provides the ability to group similar applications on the same area of the spherical surface, for example, word processing applications, or applications which are used most frequently by the end user. Generally, the ability to group icons, has the benefit of allowing the end user to gain an enhanced perception of logically grouped objects.

Preferably, as depicted in FIG. 4, in the free space outside the sphere 400, there is provided fixed widgets and tools, such as, a shutdown button 450, command line icons 460 and 470, a launch pad and so on. The locations and types of widgets and tools are preferably customisable. Therefore, the use of a spherical desktop allows increased free space to place widgets or other user interface objects. Furthermore, tools to manipulate the spherical desktop may also be provided here.

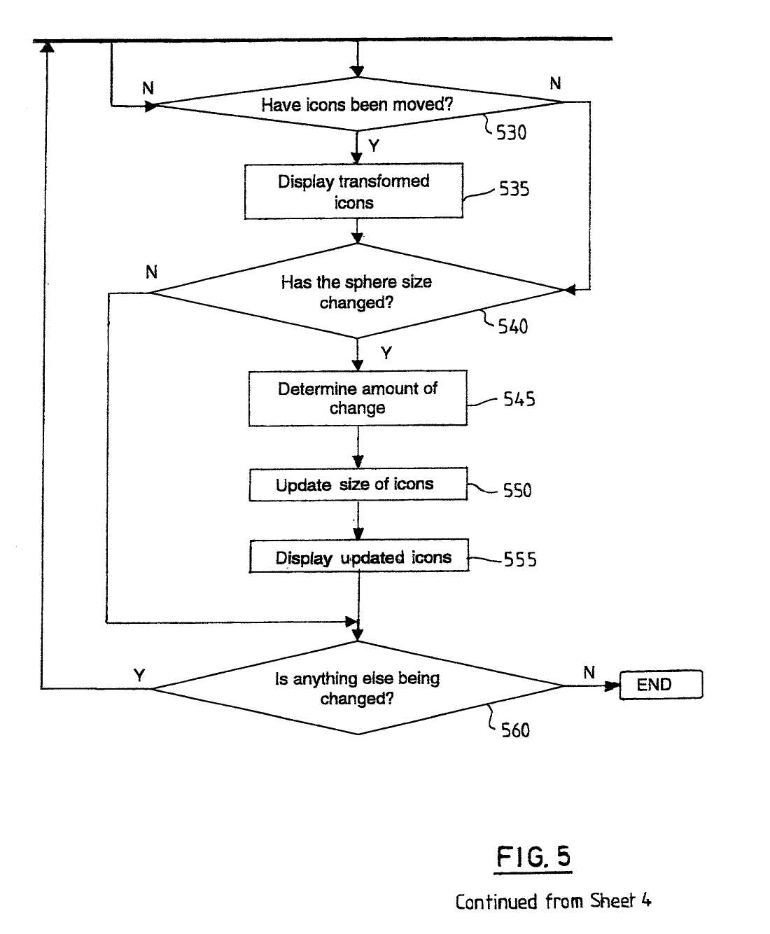

FIG. 5 shows the operational steps involved in navigating a 3-dimensional spherical desktop according to the present invention. FIG. 5 is used in conjunction with FIGS. 4, 6 and 7.

Firstly, the grouped icons are displayed 500 on spherical surface 400 to the end user as shown in FIG. 4. The spherical surface 400 can be navigated by scrolling using the pointer of a pointing device, such as a mouse pointer. The sphere 400 rotates 505 in the direction in which the pointer is moved. Upon scrolling of the desktop, each icon on its surface 400 rotates in a solid manner with it.

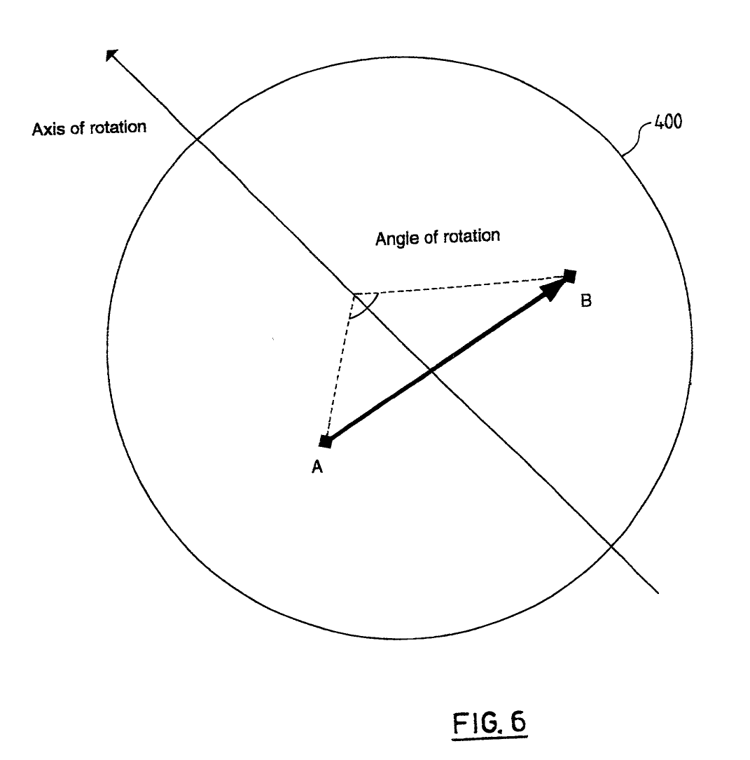

In FIG. 6, the arrow from A to B depicts the dragging of a mouse cursor. The transformation 510 of icons is implemented by storing an initial position, namely the x and y co-ordinates in terms of screen location, of each icon as integers in an array. This initial position may be the (x, y) screen location at which the icon has been dropped onto the desktop, or else by default the centre of the sphere, corresponding to icon group 420 in FIG. 4.

To depict the sphere after its rotation, the co-ordinates of each icon are transformed 510 into spherical co-ordinates. This is a standard geometric mapping, given the (x, y) position of the centre of the sphere and its radius. Referring to FIG. 6 the angle of rotation and the axis of rotation are determined 515. The axis of rotation is perpendicular to the 3-dimensional plane with A and B and the centre of the sphere. In order to determine the axis of rotation, the locations of A and B are first transformed into spherical co-ordinates, thereby allowing the axis and angle of rotation to be determined in accordance with standard spherical geometry.

The icon positions in spherical co-ordinates are next transformed 517 based on the angle and axis information to reflect the change in position of that icon, again using standard spherical geometry. The spherical co-ordinates of the new positions of the icons are then transformed 520 back into the x and y co-ordinates and these new values are stored in the array. The transformed icons are displayed 525 to the end user at their new (x, y) locations.

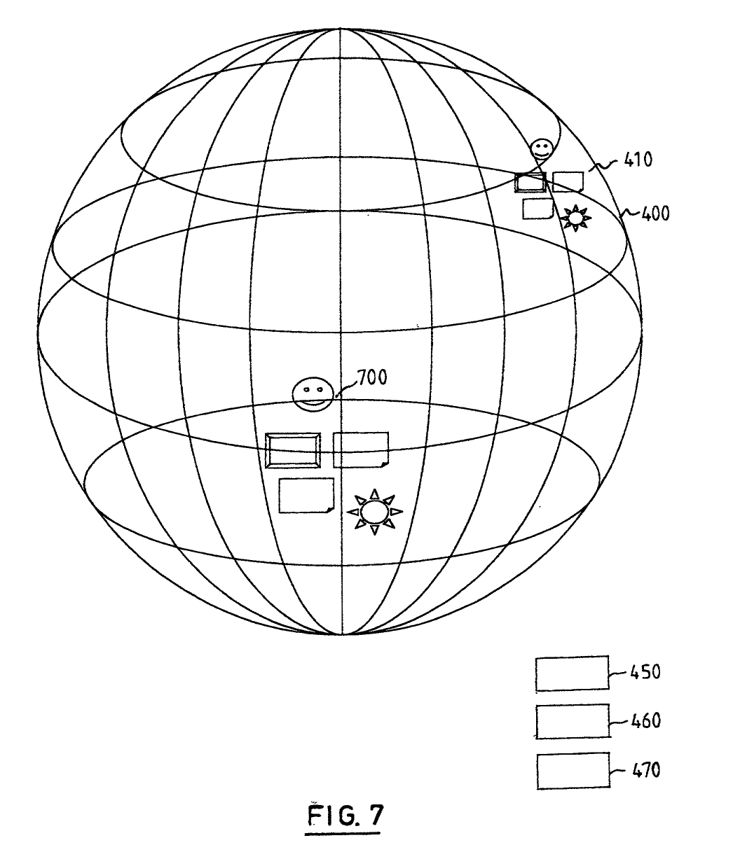

FIG. 7 shows a schematic representation of the desktop in FIG. 4 following scrolling to the left. The end user now views logical group 410 in the top right hand corner of the sphere 400. However, logical groups 420, 430 and 440 have disappeared from view. A logical group 700, which was hidden from the end user's view in FIG. 4, has appeared on the foreground of the sphere 400.

The end user also has the ability to change the position of an individual icon, to move the icon onto other areas of the sphere 400, for example, to achieve desired groupings. In the preferred embodiment, moving 530 an icon is achieved simply by dragging it with a mouse pointer across the surface of the sphere 400. In this case, the (x, y) position of the icon can be updated directly according to the final screen position of the mouse.

If an icon is to be sent to an area of the sphere 400 that is hidden from view, the icon is first dragged to the edge of the visible sphere 400 using the mouse, and then the sphere 400 is rotated 505 to display the hidden area. Finally the icon is placed onto this selected area and displayed 535 in its new position. Alternatively, once an icon is dragged past the edge of the visible sphere 400, it will cause the sphere to rotate automatically, thus displaying the hidden area. Typically, the axis of rotation is perpendicular to the line from the icon to the centre of the sphere, and the direction of rotation such as to bring the hidden surface into view adjacent to the icon. The speed of rotation can be made dependent upon, (for example, proportional to), the distance from the edge of the sphere to the icon. The icon can now be placed and displayed 535 in its new position as before. Another alternative process for moving 530 icons to hidden parts of the sphere 400 would be to provide a pop up menu, which would be implemented by clicking a mouse button. The pop up menu would provide the end user with options such as, “Send to back of sphere”.

In the preferred embodiment, icons are not strictly imprinted on the spherical surface 400 rather, the 3-dimensional surface is navigated to relatively position the icons. When an icon is displayed following a change in the icon's position to a new (x, y) location, the icon is not distorted in any way. Instead the only icon parameter that changes is the icon size. Therefore unwanted effects, such as being displayed as an elongated icon or an icon being displayed upside down, are avoided. Thus icons are always drawn in their normal proportions and the right way up.

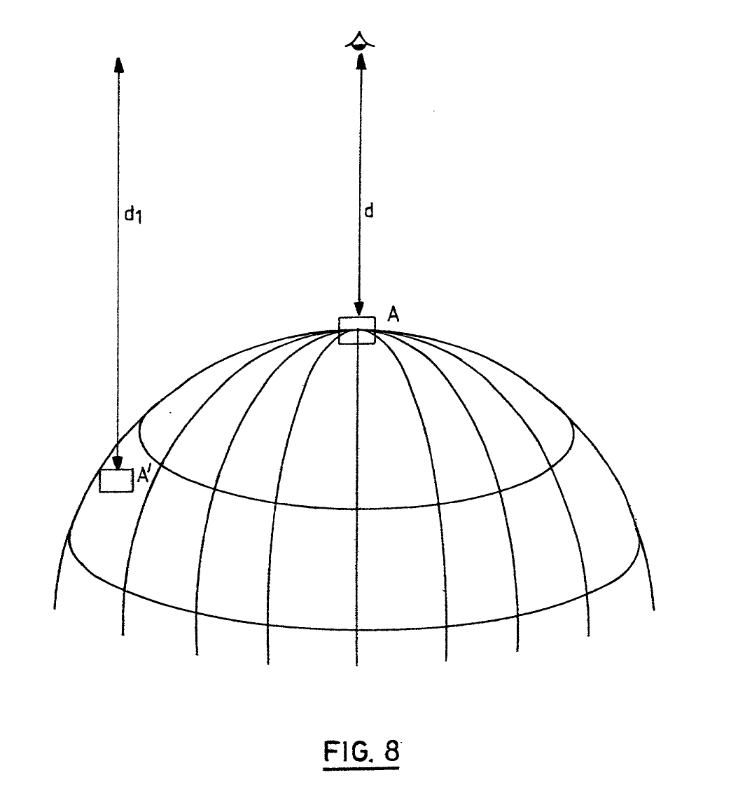

Once an icon has been positioned, the size of a displayed 535 icon is dependent on the apparent distance of the icon from the viewpoint of the end user. Thus, each icon will reduce in size when approaching the edge of the visible hemisphere 400, and will increase in size when approaching the centre point with respect to the end user's viewpoint. Referring to FIG. 8, assuming the end user is a nominal distance d from an icon located at A, namely the centre of the screen sphere corresponding to position 420 in FIG. 4. Then if the icon is moved to A′, the end user will view the icon from a nominal distance of d′. Therefore the size of the icon is scaled accordingly, that is, A′=Ad′/d, where d/d′=A/A′.

Hence, icons grouped close to the edges of the sphere 400 as shown in FIG. 4, such as 410 and 440, are displayed as being smaller in size with respect to icons on the foreground, such as 420. The appropriate scaling factor for any (x, y) location can be determined by simple geometry given the centre position and radius of the sphere.

After the icon is redrawn, the new font size of the associated window's caption is calculated using an analogous scaling as for the icon and then the string for the caption, for example, “Applications” is drawn.

In the preferred embodiment, the distance between the viewpoint of the end user and the spherical surface can be changed, enabling the end user to zoom in and out of the desktop. Additionally, the size of the sphere 400 may be changed 540. In the preferred embodiment, the end user can change 540 their view of the desktop using known methods such as utilising the mouse buttons or navigating a menu containing options for zooming or changing the sphere's size. These actions result in a change in the size of an icon.

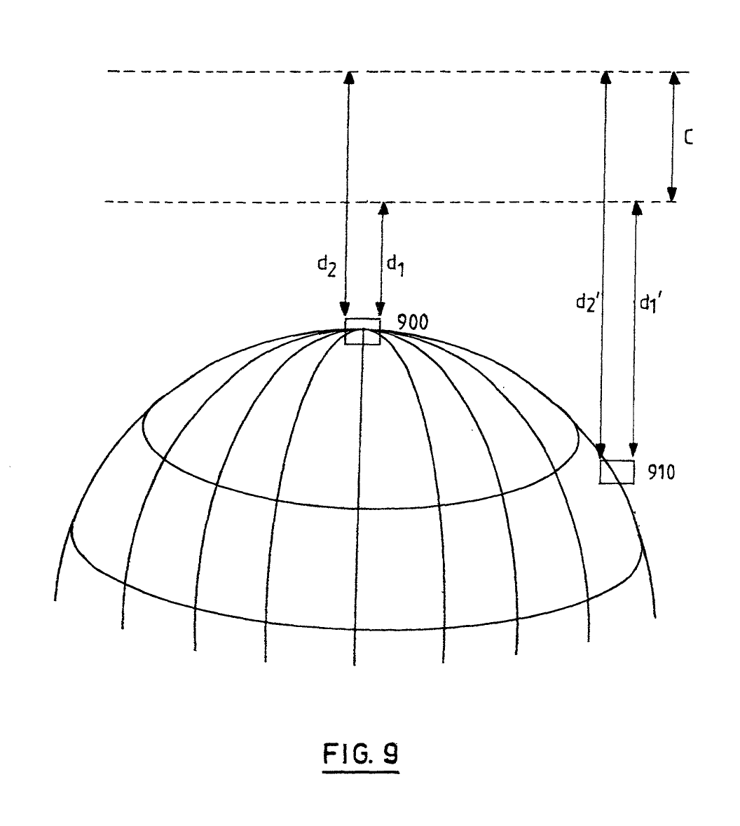

When the distance is changed, the sizes of the icons are changed relatively. So for example in FIG. 9, assume the end user is initially a nominal distance d1 from an icon 900 and a nominal distance d1′ from an icon 910. Then the scaling of the icons is represented by d1/d1′. If the distance between the end user and the sphere 400 is changed by a distance C, the scaling of the icons is now represented by d2/d2′=d1+C/d1′+C. If C is a value more than zero, that is the distance is increased, then the new scaling is nearer unity and the icons 900 and 910 will look more similar in size as well as both looking smaller due to the increase in distance. The size of the sphere itself will vary in inverse proportion to the distance.

Likewise, when the sphere size is changed 540, the amount by which the size has changed is determined 545. Assuming the size can be changed by +/−x%, where x is an integer, and the standard size is 100%, the size of the icons on the surface are then scaled 550 proportionally by x/100. So for example, if the size of the sphere is enlarged to 200%, the icons on the sphere surface are scaled by a factor of +2.

To depict the icons after the scaling it is assumed that the (x, y) co-ordinates of the centre of the sphere remain unchanged, for example (100, 100). Firstly, the distance of the original icon in (x, y) co-ordinates from the centre of the sphere on the screen is determined. Next, the distance between the end user and the sphere or the sphere size is changed by an arbitrary amount, for example the size is changed to 150. The distance of the icon on the screen from the sphere centre is then scaled by the same arbitrary amount and the new (x, y) co-ordinates for the icon, based on the scaled distance from the centre of the sphere, are determined. Therefore, the bearing of the icon from the centre is kept constant.

Thus, from our example, assuming an original icon location of (150, 200), the original x co-ordinate distance is (50) and the original y co-ordinate distance is (100). Following scaling by a factor of 1.5, the new scaled distance for the x co-ordinate is (75) and the new scaled distance for the y co-ordinate is (150). Therefore, the new (x, y) co-ordinates are (175, 250). These new values are stored in the array and the scaled icons are displayed to the end user at their new (x, y) locations.

It will be appreciated that many features of a prior art graphical user interface can be utilized in conjunction with the spherical desktop described herein. In the preferred embodiment, once an icon is opened in order to display an object, for example an application, the application may be displayed within a window in a similar fashion to current systems. These windows appear as conventional rectangles overlaid upon the view of the spherical desktop. Further examples of known features that may be supported, are the ability for icons to overlap each other on the desktop, subject to subsequent manual or automatic re-arrangement, and the ability to add wallpaper as a background to the sphere surface.

The skilled person will also be aware of many modifications and variations on the embodiment described above. For example, it should be understood that the 3-dimensional desktop could be implemented using any other suitable 3-dimensional shape, for example, an ellipsoid. Also, the scrolling of the desktop by rotation can be restricted to a limited number of axes, for example, to rotation about the NORTH—SOUTH line.

It will be apparent from the above description that, by using the technique of the preferred embodiment, a more intuitive desktop is achieved, whilst also providing a good balance with the use of the desktop area for displaying icons and windows. The present invention is also advantageous in the continuity of the view of the desktop presented to the end user.

We claim:

1. A graphical user interface system for displaying a plurality of icons, said system further comprising:
means for depicting a desktop which conceptually provides a three-dimensional surface for said icons, in which said three dimensional surface is represented on a two-dimensional display device, and
means for supporting navigation of said desktop by simulating a rotation of the desktop in three-dimensional space.

2. A graphical user interface system as claimed in claim 1, in which the desktop is viewed at an apparent distance from a user viewpoint and said means for depicting includes:
means for calculating a viewing distance for each of said plurality of icons based on the apparent distance and the location of the icon on the three-dimensional surface, and
means for scaling each of said plurality of icons by said relevant viewing distance.

3. A graphical user interface system as claimed in claim 2, further comprising:
means for changing the apparent distance between the viewpoint and the desktop.

4. A graphical user interface system as claimed in claim 1, further comprising:
an array for storing the position of each of said plurality of icons, in which the position is stored as a two-dimensional co-ordinate relative to the display device.

5. A graphical user interface system as claimed in claim 4, in which the means for supporting navigation comprises:
means for determining a new two-dimensional co-ordinate for each of said plurality of icons following rotation of the desktop, and
means for updating the array accordingly.

6. A graphical user interface system as claimed in claim 5, in which said means for determining further comprises:
means for transforming the two-dimensional co-ordinate of each of said plurality of icons into a three-dimensional co-ordinate;
means for changing the three-dimensional co-ordinates based on the rotation of the desktop, and
means for transforming the changed three-dimensional co-ordinates into a new two-dimensional co-ordinate for each of said plurality of icons.

7. A graphical user interface system as claimed in claim 1, in which an icon is initially added to the centre of the desktop by default.

8. A graphical user interface system as claimed in claim 1, in which said means for supporting navigation is responsive to dragging the desktop with a pointing device in order to rotate the desktop.

9. A graphical user interface system as claimed in claim 1, in which said means for supporting navigation is responsive to dragging an icon beyond the desktop with a pointing device in order to rotate the desktop.

10. A graphical user interface system as claimed in claim 1, in which said plurality of icons are grouped automatically according to pre-determined criteria.

11. A graphical user interface system as claimed in claim 1, in which said three-dimensional surface is spherical.

12. A computer program product for displaying a plurality of icons, said computer program product comprising computer program instructions on a computer readable medium, said instructions causing the computer to perform the steps of:
depicting a desktop which conceptually provides a three-dimensional surface for said icons, in which said three dimensional surface is represented on a two-dimensional display device, and
supporting navigation of said desktop by simulating a rotation of the desktop in three-dimensional space.

13. A computer program product as claimed in claim 12, in which the desktop is viewed at an apparent distance from a user viewpoint and said step of depicting includes the steps of:
calculating a viewing distance for each of said plurality of icons based on the apparent distance and the location of the icon on the three-dimensional surface, and
scaling each of said plurality of icons by said relevant viewing distance.

14. A computer program product as claimed in claim 13, further comprising the step of:
changing the apparent distance between the viewpoint and the desktop.

15. A computer program product as claimed in claim 12, further comprising:
an array in memory for storing the position of each of said plurality of icons, in which the position is stored as a two-dimensional co-ordinate relative to the display device.

16. A computer program product as claimed in claim 15, in which the step of supporting navigation further comprises the steps of:
determining a new two-dimensional co-ordinate for each of said plurality of icons following rotation of the desktop, and
updating the array accordingly.

17. A computer program product as claimed in claim 16, in which the step of determining further comprise the steps of:
transforming the two-dimensional co-ordinate of each of said plurality of icons into a three-dimensional co-ordinate;
changing the three-dimensional co-ordinates based on the rotation of the desktop, and
transforming the changed three-dimensional co-ordinates into a new two-dimensional co-ordinate for each of said plurality of icons.

18. A computer program product as claimed in claim 12, in which an icon is initially added to the centre of the desktop by default.

19. A computer program product as claimed in claim 12, in which said step of supporting navigation is responsive to dragging the desktop with a pointing device in order to rotate the desktop.

20. A computer program product as claimed in claim 12, in which said step of supporting navigation is responsive to dragging an icon beyond the desktop with a pointing device in order to rotate the desktop.

21. A computer program product as claimed in claim 12, in which said plurality of icons are grouped automatically according to pre-determined criteria.

22. A computer program product as claimed in claim 12, in which said three-dimensional surface is spherical.
